(19) United States
(12) Patent Application Publication
(10) Pub. No.: US 2018/0070010 A1
(43) Pub. Date: Mar. 8, 2018

(54) IMAGE CAPTURING APPARATUS AND IMAGE ZOOMING METHOD THEREOF

(71) Applicant: Altek Semiconductor Corp., Hsinchu City (TW)

(72) Inventors: Yu-Chih Wang, Hsinchu City (TW); Shou-Te Wei, Hsinchu City (TW); Yao-Sheng Wang, Hsinchu City (TW); Chi-Ying Huang, Hsinchu City (TW); Cheng-Ming Chen, Hsinchu City (TW)

(73) Assignee: Altek Semiconductor Corp., Hsinchu City (TW)

(21) Appl. No.: 15/595,922

(22) Filed: May 15, 2017

Related U.S. Application Data
(60) Provisional application No. 62/382,787, filed on Sep. 2, 2016.

(30) Foreign Application Priority Data
Jan. 23, 2017 (TW) 106102481

(51) Int. Cl. H04N 5/232; G06T 7/11

(52) U.S. Cl. CPC H04N 5/23238; G06T 7/11; H04N 5/23296

(57) ABSTRACT

An image capturing apparatus and an image zooming method thereof are provided. In the method, a wide image and a tele image are captured by utilizing a wide-angle lens and a telephoto lens respectively. An object of interest in the wide image or the tele image is recognized. Then, a zoom factor is received to zoom the wide image or the tele image, and a capture range of a window of interest (WOI) for capturing each of the wide image and the tele image is adjusted in a zooming process such that a center of the wide image captured by the window of interest moves toward the object of interest. Also, when the zoom factor reaches a magnification of the telephoto lens, the object of interest is as the same position in the wide image and the tele image captured from the window of interest.

### CROSS-REFERENCE TO RELATED APPLICATION

This application claims the priority benefits of U.S. provisional application Ser. No. 62/382,787, filed on Sep. 2, 2016 and Taiwan application Ser. No. 106102481, filed on Jan. 23, 2017. The entirety of each of the above-mentioned patent applications is hereby incorporated by reference herein and made a part of this specification.

### BACKGROUND OF THE INVENTION

### Field of the Invention

The invention relates to an image capturing apparatus and an image processing method, and particularly relates to an image capturing apparatus and an image zooming method thereof.

### Description of Related Art

With the advances in image capturing technology, digital camera pixels are significantly increased. However, a size of the camera is relatively decreased, so that the camera can be configured on portable electronic devices, such as mobile phones and tablet computers, for a user to capture images anytime and anywhere. To achieve a zoom function of the camera on the mobile phones and the tablet computers, many products on the market will be equipped with a wide-angle lens and a telephoto lens with different fields of view (FOV) simultaneously. As a wide-angle lens 12 and a telephoto lens 14 shown in FIG. 1, a magnification of the wide-angle lens 12 is Z_{wide} and the wide-angle lens 12 has a larger field of view and a shorter focal length, and a magnification of the telephoto lens 14 is Zₜₑₗₑ and the wide-angle lens 12 has a smaller field of view and a longer focal length. With the combination of these two lenses, an optical zoom-like function can be provided for the user to freely adjust a zoom factor to see a zoomed image with different magnifications.

The zoomed image is a result obtained by the electronic device performing cropping, alignment, fusing, or other processing on the images captured by the dual lens, which can be obtained from a wide image captured by the wide-angle lens, a tele image captured by the telephoto lens, or the both. Specifically, according to the input zoom factor, the electronic device will capture a portion of the image from the wide image or the tele image to scale-up, so as to provide an image meeting the zoom factor, for example. Alternatively, the electronic device will fuse two images to generate a composite image, wherein the tele image is used as a center portion of the composite image, and the wide image is used as a peripheral portion of the composite image. The resulting composite image will be approximate to an image after optical zooming.

In some cases, the electronic device only performs digital zoom to obtain the zoomed image. That is, the zoomed image is formed by scaling-up a portion cropping from the wide image or the tele image. Specifically, FIG. 2 is a schematic diagram of zooming an image of a conventional dual lens apparatus. Referring to FIG. 1, the conventional dual lens apparatus respectively captures a wide image 22 and a tele image 24 by utilizing a wide-angle lens and a telephoto lens and captures a zoomed image from the wide image 22 or the tele image 24 according to a zoom factor ZF input by the user. If the zoom factor ZF input by the user is between the magnification Zₜₑₗₑ of the telephoto lens and the magnification Z_{wide} of the wide-angle lens, the dual lens apparatus will use the wide image 22 to generate the zoomed image. That is, an image 22a in a center portion of the wide image 22 is captured and scaled-up to a zoomed image 22b according to the zoom factor ZF. If the zoom factor ZF input by the user is higher than or equal to the magnification Zₜₑₗₑ of the telephoto lens, the dual lens apparatus will use the tele image 24 to generate the zoomed image. That is, an image 24a in a center portion of the tele image 24 is captured and scaled-up to a zoomed image 24b according to the zoom factor ZF. When the zoom factor ZF input by the user is increased from below the magnification Zₜₑₗₑ to above the magnification Zₜₑₗₑ, the target from which the dual lens apparatus captures the zoomed image will be switched from the wide image 22 to the tele image 24 at the moment when the zoom factor ZF is just equal to the magnification Zₜₑₗₑ.

However, when the dual lens apparatus switches between the wide image and the tele image, the user usually sees a discontinuous image change due to different viewing angles of the wide-angle lens and the telephoto lens.

Specifically, FIG. 3 is a schematic diagram of a viewing angle difference between the wide-angle lens and the telephoto lens in FIG. 1. Referring to FIG. 3, the wide-angle lens 12 and the telephoto lens 14 are separated from each other with a gap (with a length d) and the images captured by the two lenses will be slightly different. For example, an image point B′ in the wide image 12a may correspond to image points A″ and B″ in the tele image 14a. This is because an object A will be occluded by an object B in the viewing angle of the wide image 12a. Thus, only the image point B′ will be seen in the wide image 12a.

FIG. 4 is a schematic diagram of zooming an image of a conventional dual lens apparatus. Referring to FIG. 4, when the zoom factor input by the user is between the magnification Z_{wide} of the wide-angle lens and the magnification Zₜₑₗₑ of the telephoto lens, the electronic device will directly capture an image 42a in the center portion of a wide image 42 and scale-up it to a zoomed image 42b. When the zoom factor input by the user is equal to the magnification Zₜₑₗₑ of the telephoto lens, the electronic device will switch the displayed zoomed image from the magnified image 42b of the image 42a in the center portion of the wide image 22 to a tele image 44. From the comparison of the magnified image 42b and the tele image 44, it can be found that the position of the object of interest C has a deviation. The deviation will cause the user to see the object of interest C suddenly jumps to another position when the electronic device switches from the magnified image 42b to the tele image 44, thereby affecting the perception of the user.

### SUMMARY OF THE INVENTION

The invention provides an image capturing apparatus and an image zooming method thereof which can reduce a discontinuous image change in an image switching process.

The invention provides an image zooming method of an image capturing apparatus, adapted to the image capturing apparatus with a wide-angle lens and a telephoto lens. The method respectively captures a wide image and a tele image by utilizing the wide-angle lens and the telephoto lens, and then recognizes an object of interest in the wide image and the tele image. Then, a zoom factor is received to zoom the wide image or the tele image, and a capture range of a window of interest (WOI) for capturing the wide image is adjusted in a zooming process, such that a center of the wide image captured by the window of interest moves toward the object of interest. Also, when the zoom factor reaches a magnification of the telephoto lens, the object of interest is at the same position in the wide image captured by the window of interest and the tele image.

According to an embodiment of the invention, the step of adjusting the capture range of the window of interest for capturing the wide image and the tele image in the zooming process such that the center of the wide image captured by the window of interest moves toward the object of interest includes the following steps. At least one feature point and at least one corresponding matching point of the object of interest are captured in the wide image and the tele image. Then, a corresponding virtual center of the center of the tele image in the wide image is calculated by utilizing the feature point and the matching point. A plurality of intermediate points between the center of the wide image and the virtual center are calculated to be used as centers of the window of interest for capturing a zoomed image in the zooming process according to the center of the wide image, the virtual center of the tele image, and the zoom factor. At last, the zoomed image is captured from the wide image and the tele image by utilizing the window of interest according to the center of the window of interest and the zoom factor.

According to an embodiment of the invention, the step of capturing the feature point and the corresponding matching point of the object of interest in the wide image and the tele image includes the following steps. The feature point of the object of interest in the wide image is captured, and the matching point corresponding to the feature point in the tele image is searched.

According to an embodiment of the invention, the step of calculating the corresponding virtual center of the center of the tele image in the wide image by utilizing the feature point and the matching point includes the following steps. A vector from each matching point in the tele image to the center of the tele image is calculated. The vector is multiplied by a ratio of the magnification of the wide-angle lens to the magnification of the telephoto lens to obtain a convert vector. The feature point corresponding to the matching point in the wide-angle lens plus the convert vector to calculate the corresponding virtual center of the center of the tele image in the wide image.

According to an embodiment of the invention, the step of capturing the feature point and the corresponding matching point of the object of interest in the wide image and the tele image includes the following steps. The feature point of the object of interest in the tele image is captured, and the matching point corresponding to the feature point in the wide image is searched.

According to an embodiment of the invention, the step of calculating the corresponding virtual center of the center of the tele image in the wide image by utilizing the feature point and the matching point includes the following steps. A vector from each feature point in the tele image to the center of the tele image is calculated. The vector is multiplied by a ratio of the magnification of the wide-angle lens to the magnification of the telephoto lens to obtain a convert vector. The matching point corresponding to the feature point in the wide-angle lens plus the convert vector to calculate the corresponding virtual center of the center of the tele image in the wide image.

According to an embodiment of the invention, the step of calculating the plurality of intermediate points between the center of the wide image and the virtual center to be used as the centers of the window of interest for capturing the zoomed image in the zooming process according to the center of the wide image, the virtual center of the tele image, and the zoom factor includes the following step. The intermediate points are inserted between the center of the wide image and the virtual center according to a proportional relationship between the zoom factor and the magnifications of the wide-angle lens and the telephoto lens.

According to an embodiment of the invention, the method further includes the following step. A size of the wide image is multiplied by a ratio of the magnification of the wide-angle lens to the corresponding zoom factor of each window of interest in the zooming process to obtain a size of the window of interest.

According to an embodiment of the invention, the step of capturing the zoomed image from the wide image and the tele image by utilizing the window of interest according to the center of the window of interest and the zoom factor further includes the following step. Whether the scene has a change in the wide image and the tele image is determined. If there is a change, the intermediate points between the center of the window of interest and the virtual center are calculated to be used as the centers of the window of interest for capturing the zoomed image in the subsequent zooming process according to the center of the window of interest, the virtual center of the tele image, and the zoom factor which are currently used.

The invention provides an image capturing apparatus including a wide-angle lens, a telephoto lens, and an image processing circuit. The wide-angle lens is used to capture a wide image, and the telephoto lens is used to capture a tele image. The image processing circuit is coupled to the wide-angle lens and the telephoto lens and used to process the wide image and the tele image to generate a zoomed image. The image processing circuit includes an object of interest recognition module and a zoomed image capture module. The object of interest recognition module is used to recognize an object of interest in the wide image or the tele image. The zoomed image capture module is used to receive a zoom factor to zoom the wide image or the tele image and adjust a capture range of a window of interest for capturing the wide image in a zooming process, such that a center of the wide image captured by the window of interest moves toward the object of interest. When the zoom factor reaches a magnification of the telephoto lens, the object of interest is at the same position in the wide image captured by the window of interest and the tele image.

According to an embodiment of the invention, the object of interest recognition module includes capturing at least one feature point and at least one corresponding matching point of the object of interest in the wide image and the tele image. The zoomed image capture module includes calculating a corresponding virtual center of the center of the tele image in the wide image by utilizing the feature point and the matching point, calculating a plurality of intermediate points between the center of the wide image and the virtual center to be used as centers of the window of interest for capturing the zoomed image in the zooming process according to the center of the wide image, the virtual center of the tele image, and the zoom factor, and capturing the zoomed image from the wide image by utilizing the window of interest according to the center of the window of interest and the zoom factor.

According to an embodiment of the invention, the object of interest recognition module includes capturing the feature points of the object of interest in the wide image and searching the matching points corresponding to the feature points in the tele image.

According to an embodiment of the invention, the zoomed image capture module includes calculating a vector from each matching point in the tele image to the center of the tele image, multiplying the vector by a ratio of the magnification of the wide-angle lens to the magnification of the telephoto lens to obtain a convert vector, and calculating the corresponding virtual center of the center of the tele image in the wide image from the feature point corresponding to the matching point in the wide-angle lens plus the convert vector.

According to an embodiment of the invention, the object of interest recognition module includes capturing the feature points of the object of interest in the tele image and searching the matching points corresponding to the feature points in the wide image.

According to an embodiment of the invention, the zoomed image capture module includes calculating a vector from each feature point in the tele image to the center of the tele image, multiplying the vector by a ratio of the magnification of the wide-angle lens to the magnification of the telephoto lens to obtain a convert vector, and calculating the corresponding virtual center of the center of the tele image in the wide image from the matching point corresponding to the feature point in the wide-angle lens plus the convert vector.

According to an embodiment of the invention, the zoomed image capture module includes inserting the intermediate points between the center of the wide image and the virtual center according to a proportional relationship between the zoom factor and the magnifications of the wide-angle lens and the telephoto lens.

According to an embodiment of the invention, the zoomed image capture module further multiplies the size of the wide image by a ratio of the magnification of the wide-angle lens to the zoom factor corresponding to each window of interest in the zooming process to obtain the size of the window of interest.

According to an embodiment of the invention, the image processing circuit further includes a scene determination module, which is used to determine whether the scene has a change in the wide image and the tele image. If there is a change, the zoomed image capture module will calculate the intermediate points between the center of the window of interest and the virtual center to be used as the centers of the window of interest for capturing the zoomed image in the subsequent zooming process according to the center of the window of interest, the virtual center of the tele image, and the zoom factor which are currently used.

Based on the above, in the image capturing apparatus and the image zooming method thereof of the invention, the window of interest for capturing the zoomed image in the zooming process is defined by finding out the object of interest in the wide or tele images and making the object of interest as the center. Since the center of the zoomed image is gradually transferred onto the object of interest in the zooming process by the window of interest, the object of interest is at the same position in the image when the image capturing apparatus switches from the wide image to the tele image. Thus, the discontinuous feeling caused by the bumping of the subject object in the image can be reduced.

In order to make the aforementioned features and advantages of the disclosure more comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a field of view of each of a conventional wide-angle lens and telephoto lens.

FIG. 2 is a schematic diagram of zooming image of a conventional dual lens apparatus.

FIG. 3 is a schematic diagram of a viewing angle difference between the wide-angle lens and the telephoto lens in FIG. 1.

FIG. 4 is a schematic diagram of zooming image of a conventional dual lens apparatus.

FIG. 5 is a schematic diagram illustrating an image zooming method of an image capturing apparatus according to an embodiment of the invention.

FIG. 6 is a block diagram illustrating an image capturing apparatus according to an embodiment of the invention.

FIG. 7 is a flow chart illustrating an image zooming method of an image capturing apparatus according to an embodiment of the invention.

FIG. 8 is a flow chart illustrating an image zooming method of an image capturing apparatus according to an embodiment of the invention.

FIG. 9A to FIG. 9D are schematic diagrams illustrating defining a window of interest according to an embodiment of the invention.

FIG. 10 is a schematic diagram illustrating defining a window of interest according to an embodiment of the invention.

### DESCRIPTION OF THE EMBODIMENTS

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

Compared with the conventional method that the image capturing apparatus captures a center portion of the wide image to scale-up when zooming image, the invention is to select a capture portion to scale-up based on the position of the object of interest in the wide image or the tele image. Specifically, in the invention, the object of interest in the wide image and the tele image is recognized, and a window of interest (WOI) for capturing the zoomed image is defined according to a corresponding position of the object of interest in the wide image and the tele image, thereby capturing images in the window of interest to scale-up to be used as the zoomed image. Moreover, in the invention, a scene change is monitored in a zooming process, and the position of the window of interest is recalculated using the most recent use of the position of the window of interest as a start point to recalculate the position of the window of interest in the subsequent zooming process when the scene change is detected. Thus, in the image zooming process, the center of the captured zoomed image is gradually transferred from the center of the wide image onto the object of interest, thereby reducing the discontinuity caused by the jumping of the subject object in the image.

FIG. 5 is a schematic diagram illustrating an image zooming method of an image capturing apparatus according to an embodiment of the invention. Referring to FIG. 5, the embodiment illustrates the process of the image capturing apparatus switching from a wide image 52 to a tele image 54 when zooming the image. The image capturing apparatus may recognize an object of interest D in the wide image 52 and the tele image 54 and determine a window of interest 52a according to the position of the object of interest D in the wide image 52, for example. In the embodiment, the window of interest 52a uses the position of the object of interest D in the wide image 52 as a center. In other embodiments, the position of the window of interest 52a also can be determined by referring to the position of the object of interest D in the tele image 54. The size of the window of interest 52a is determined according to the zoom factor input by the user, and the image in the window of interest 52a will be scaled-up to a zoomed image 52b. The magnified region is adjusted by the window of interest 52a. When the zoom factor is equal to the magnification Zₜₑₗₑ of the telephoto lens, the object of interest D in the zoomed image 52b by scaling-up the image in the window of interest 52a and the object of interest D in the telephoto lens 54 will be at the same position. By adjusting the object of interest D which the user is concerned about to the same position in the zooming process, the image discontinuous perception of the user generated by the bumping of the position of the object of interest D can be reduced when the image capturing apparatus switches the image.

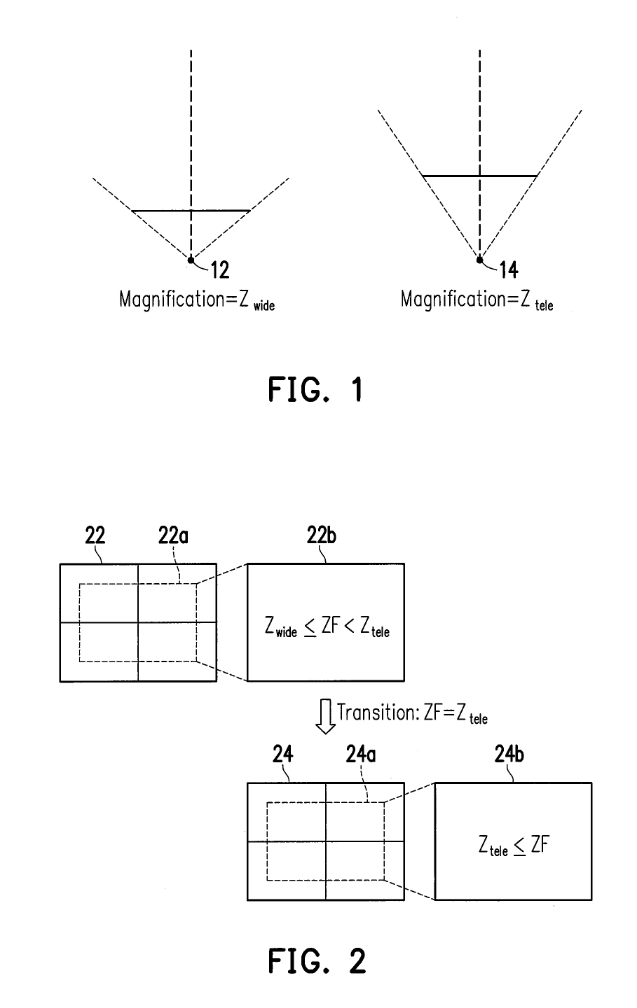

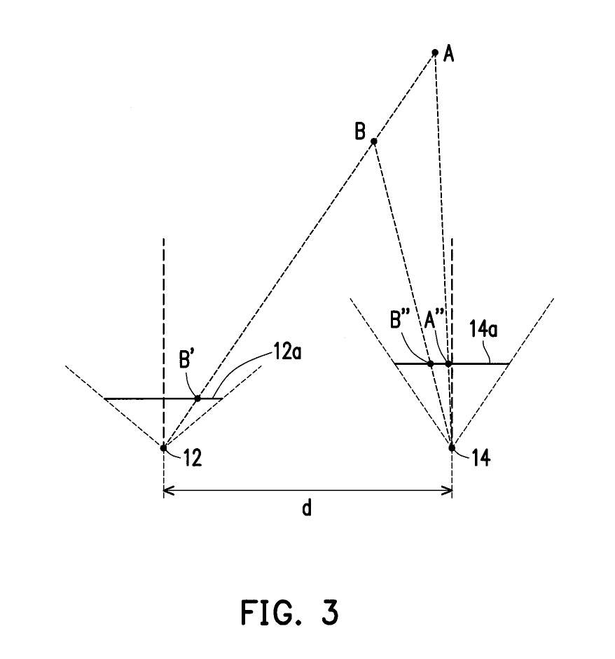

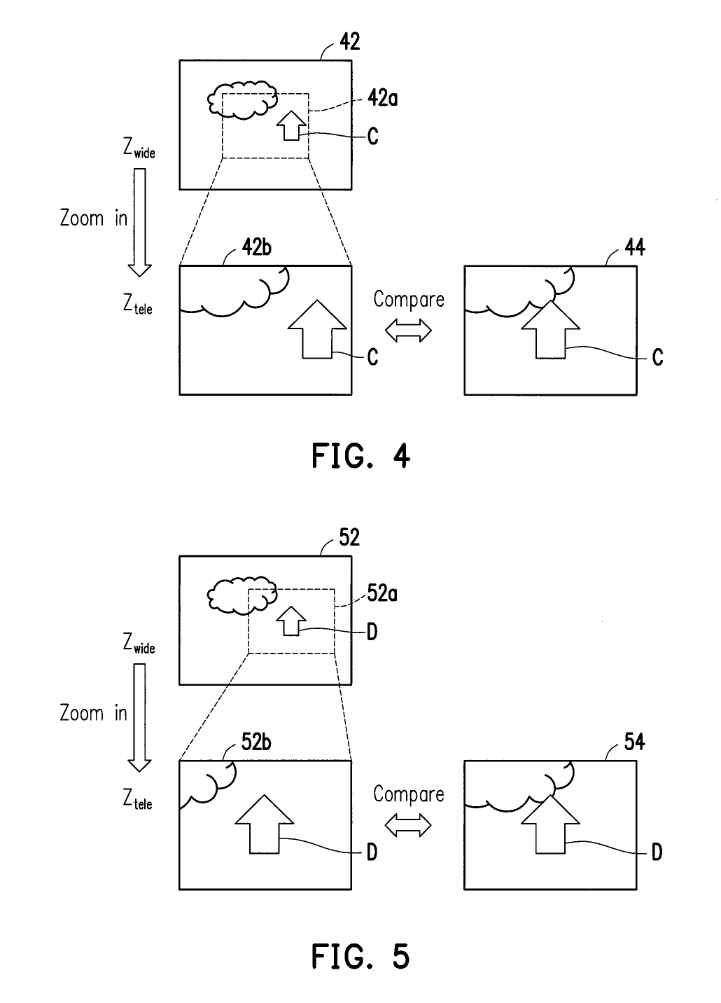

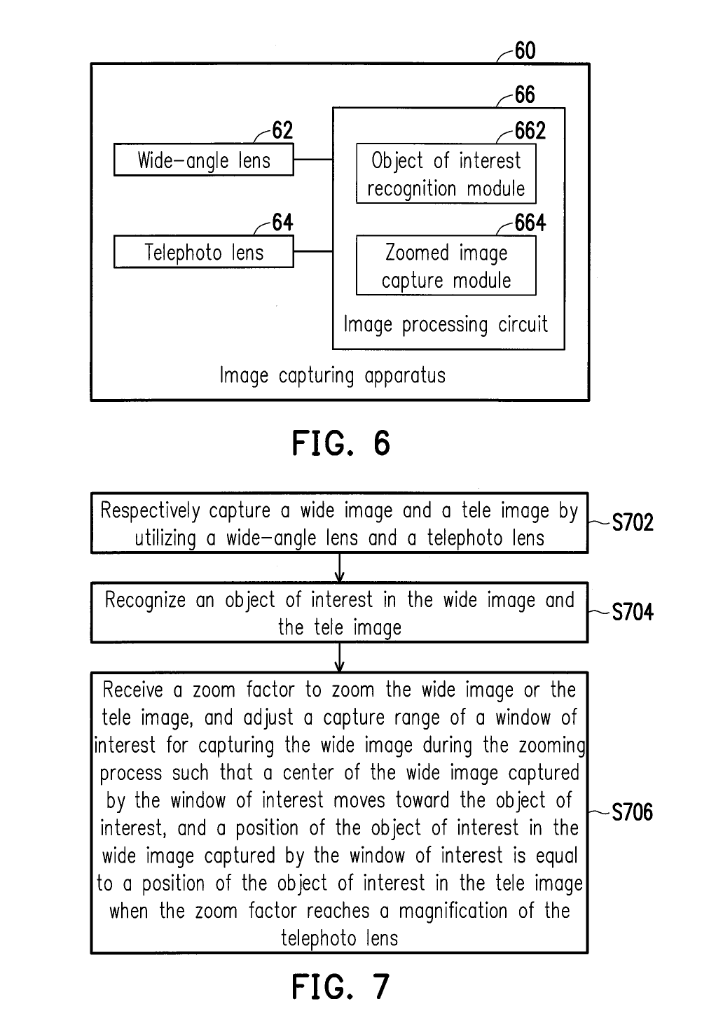

FIG. 6 is a block diagram illustrating an image capturing apparatus according to an embodiment of the invention. Referring to FIG. 1, an image capturing apparatus 60 of the embodiment is a digital camera, a digital video camcorder (DVC), or a portable electronic device, such as a mobile phone or a tablet computer, which can provide a camera function, for example. The image capturing apparatus 60 includes a wide-angle lens 62, a telephoto lens 64, and an image processing circuit 66, and the functions are described below.

The wide-angle lens 62 and the telephoto lens 64 respectively include an optical lens, an actuator, aperture, a shutter, an image sensor, and other components. The optical lens is composed of several concave convex lenses, and is driven by the actuator, such as a stepping motor or a voice coil motor (VCM), to change the relative position between the lenses, thereby changing the focal length. The aperture is a ring-shaped opening composed of many metal blades. The opening may be opened or shrunk with the size of the aperture value, thereby controlling an amount of light of the optical lens. The shutter is used to control the length of time of the light entering the optical lens and the combination with the aperture may affect an amount of exposure of the image captured by the image sensor. The image sensor is provided with a charge coupled device (CCD), a complementary metal-oxide semiconductor (CMOS) device, or other types of photosensitive components, so as to sense the light intensity entering the optical lens to generate the image. In the embodiment, the wide-angle lens 62 has a larger magnification and field of view (FOV) and a shorter focal length, and the telephoto lens 64 has a smaller magnification and field of view and a longer focal length.

The image processing circuit 66 includes an object of interest recognition module 662 and a zoomed image capture module 664. In an embodiment, each of the modules in the image processing circuit 66 takes the form of an integrated circuit (IC), for example, so as to achieve the image zooming method of the embodiment of the invention. In another embodiment, the image processing circuit 66 includes a storage device and a processor, for example. The storage device is a hard disc or a memory with a data storage function, for example, and the processor is a central processing unit (CPU), a microprocessor, a digital signal processor, programmable controller, application specific integrated circuits (ASIC), a programmable logic device (PLD), or other devices with a data operation function, for example. Each of the modules in the image processing circuit 66 is a computer program stored in the storage device, for example. The programs may be loaded via the processor to execute the image zooming method of the embodiment of the invention.

Specifically, FIG. 7 is a flow chart illustrating an image zooming method of an image capturing apparatus according to an embodiment of the invention. Referring to FIG. 6 and FIG. 7 at the same time, the method of the embodiment is adapted to the image capturing apparatus 60 of FIG. 6. Hereinafter, the detailed steps of the image zooming method of the embodiment are described with each component of the image capturing apparatus 60 in FIG. 6.

First, the wide image and the tele image are respectively captured by utilizing the wide-angle lens 62 and the telephoto lens 64 (Step S702). The image capturing apparatus 60 triggers the wide-angle lens 62 and the telephoto lens 64 to capture the image simultaneously after the user presses a shutter button, for example.

Then, the object of interest recognition module 662 recognizes an object of interest in the wide image and the tele image (Step S704). The object of interest recognition module 662 may recognize the object of interest according to the focus position of the wide-angle lens 62 and the telephoto lens 64, or human images or moving objects in the wide image and the tele image, for example.

Then, the zoomed image capture module 644 may receive the zoom factor to zoom the wide image or the tele image and adjust a capture range of the window of interest (WOI) for capturing the wide image and the tele image in the zooming process, such that the center of the wide image captured by the window of interest moves toward the object of interest. Also, when the zoom factor reaches the magnification of the telephoto lens, a position of the object of interest in the wide image captured in the window of interest is equal to a position of the object of interest in the tele image (Step S706). The zoomed image capture module 664 may move the capture range of the window of interest for capturing the wide image according to the position of object of interest in the tele image, such that the captured wide image gradually moves toward the object of interest. Finally, when zooming to the magnification of the telephoto lens, the object of interest will be at the same position in the wide image captured by the window of interest and the tele image. For example, in FIG. 5, the object of interest D in the zoomed image 52b by scaling-up the image in the window of interest 52a and the object of interest D in the tele image 54 will be at the same position.

In the zooming process, the image captured by the zoomed image capture module 668 may be sequentially displayed on a display (not shown) of the image capturing apparatus 60 for the user to see the image zooming process. Since the image displayed by the image capturing apparatus 60 may gradually move toward the object of interest in the zooming process, even if the magnification to be zoomed required by the user is higher than the magnification of the telephoto lens 64 such that the image capturing apparatus 60 must switch from the wide image to the tele image to continue the image zooming (at the moment when the zoom factor is equal to the magnification of the telephoto lens 64, the field of view of the zoomed image captured in the wide image has been moved onto the object of interest to overlap with the position of the object of interest in the tele image), the user will not notice that the object of interest has any significant changes in the image switching process.

Thus, since the position and the size of the object of interest which the user is concerned about have no significant change before and after the switching, the image discontinuity perception of the user caused by the image switching can be reduced.

It should be noted that the method of the embodiment is suitable for the case that the zoom factor is from small to large and the zoomed image is switched from the wide image to the tele image, it is also suitable for the case that the zoom factor is from large to small and the zoomed image is switched from the tele image to the wide image. That is to say, no matter the preset magnification and the received zoom factor are large or small, the method of the embodiment can make the object of interest in the zoomed image captured by the wide image and the object of interest in the zoomed image captured by the tele image be at the same position at the moment of zooming to the magnification of the telephoto lens by moving the center of the wide image captured by the window of interest toward the object of interest. Thus, the user will not notice that the object of interest has any significant changes in the image switching process.

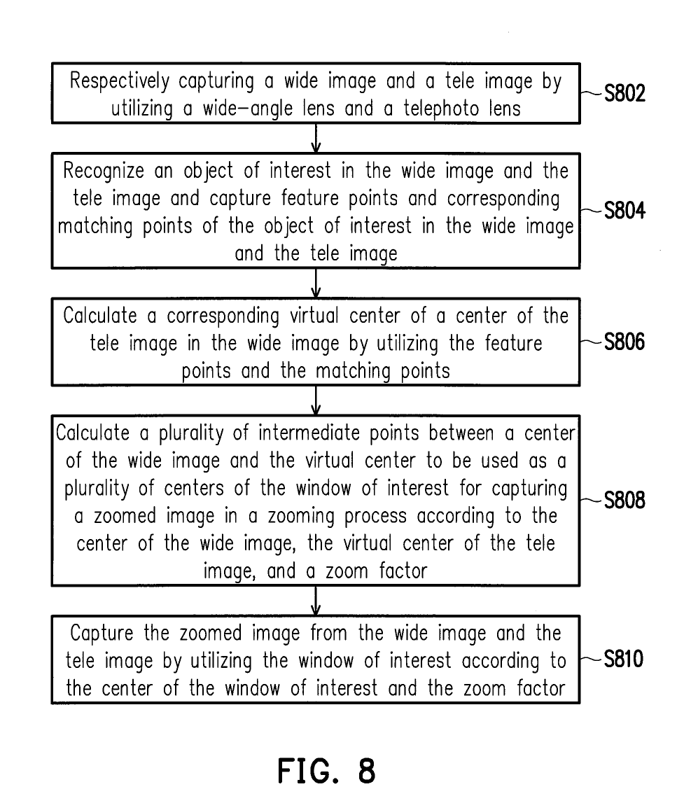

For example, for the case that the zoom factor is from small to large and the zoomed image is switched from the wide image to the tele image, FIG. 8 is a flow chart illustrating an image zooming method of an image capturing apparatus according to an embodiment of the invention. Referring to FIG. 6 and FIG. 8 at the same time, the method of the embodiment is suitable for the image capturing apparatus 60 of FIG. 6. Hereinafter, the detailed steps of the image zooming method of the embodiment are described with each component of the image capturing apparatus 60 in FIG. 6.

First, the wide image and the tele image are respectively captured by utilizing the wide-angle lens 62 and the telephoto lens 64 (Step S802). The image capturing apparatus 60 triggers the wide-angle lens 62 and the telephoto lens 64 to capture the image simultaneously after the user presses the shutter button, for example.

Then, the object of interest recognition module 662 recognizes an object of interest in the wide image and the tele image and captures feature points and corresponding matching points of the object of interest in the wide image and the tele image (Step S804). In an embodiment the object of interest recognition module 662 may capture the feature points of the object of interest in the wide image and search the matching points corresponding to the feature points in the tele image. In another embodiment, the object of interest recognition module 662 may capture the feature points of the object of interest in the tele image and search the matching points corresponding to the feature points in the wide image. The feature point captured by the object of interest recognition module 662 may be one or multiple feature points of the object of interest, and is not limited to the embodiment.

Then, the zoomed image capture module 664 calculates a corresponding virtual center of the center of the tele image in the wide image by utilizing the feature points and the matching points captured by the object of interest recognition module 662 (Step S806). Specifically, the zoomed image capture module 644 may calculate a vector from the matching point in the tele image to the center of the tele image first, multiply the vector by a ratio of the magnification of the wide-angle lens to the magnification the telephoto lens to obtain a convert vector, and adds the convert vector to the feature point corresponding to the matching point in the wide-angle lens, thereby deriving the corresponding virtual center of the center of the tele image in the wide-angle lens.

Thereafter, the zoomed image capture module 664 calculates a plurality of intermediate points between the center of the wide image and the virtual center to be used as a plurality of centers of the window of interest for capturing the zoomed image in the zooming process according to the center of the wide image, the virtual center of the tele image, and the zoom factor (Step S808). Specifically, the zoomed image capture module 664 inserts the plurality of intermediate points between the center of the wide image and the virtual center to be used as the plurality of centers of the window of interest according to a proportional relationship between the zoom factor and the magnifications of the wide-angle lens and the telephoto lens, for example. The zoomed image capture module 664 further multiplies the size of the wide image by a ratio of the magnification of the wide-angle lens 62 to the corresponding zoom factor of the window of interest in the zooming process to obtain the size of the window of interest.

At last, the zoomed image capture module 664 captures the zoomed image from the wide image and the tele image by utilizing the window of interest according to the calculated center of the window of interest and the zoom factor (Step S810). In the zooming process, the zoomed image captured by the zoomed image capture module 664 may be sequentially displayed on a display (not shown) of the image capturing apparatus 60 for the user to see the image zooming process. Since the image displayed by the image capturing apparatus 60 may gradually move toward the object of interest in the zooming process, even if the magnification to be zoomed required by the user is higher than the magnification of the telephoto lens 64 such that the image capturing apparatus 60 must switch from the wide image to the tele image to continue the image zooming (at the moment when the zoom factor is equal to the magnification of the telephoto lens 64, the field of view of the zoomed image captured in the wide image has been moved onto the object of interest to overlap with the position of the object of interest in the tele image), the user will not notice that the object of interest has any significant changes in the image switching process.

It should be noted that, although the method of capturing the zoomed image by moving the window of interest in the wide image of the embodiment may ensure that the position of the object of interest remains unchanged in the image switching process, the background portion of the zoomed image still have a deviation in the image switching process due to different viewing angles of the wide-angle lens 62 and the telephoto lens 64. However, since the user's attention is usually focused on the object of interest in the image, rather than the background, the image discontinuity generated in the image switching process that may be noticed by the user can be reduced or avoided by using the method of the embodiment.

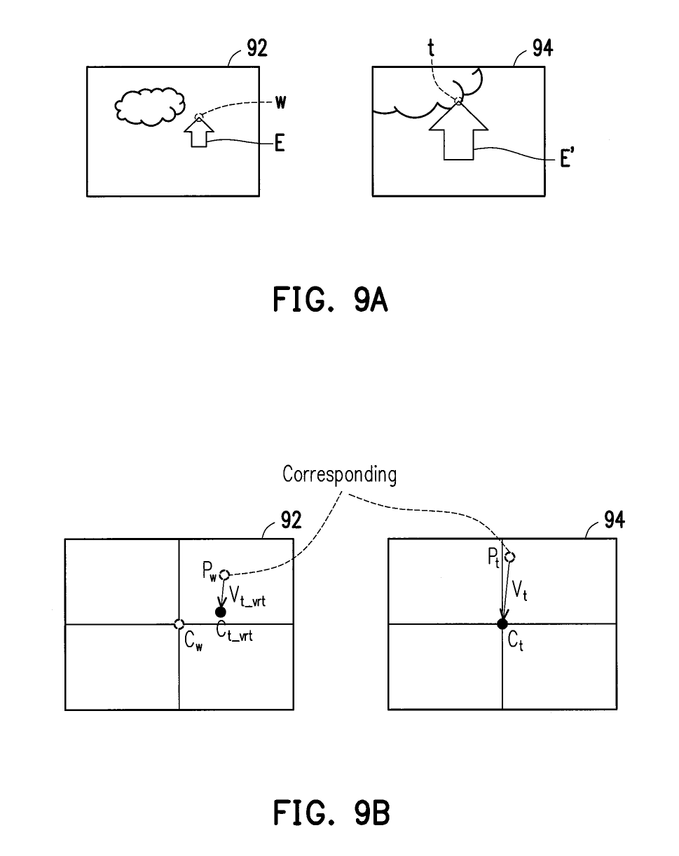

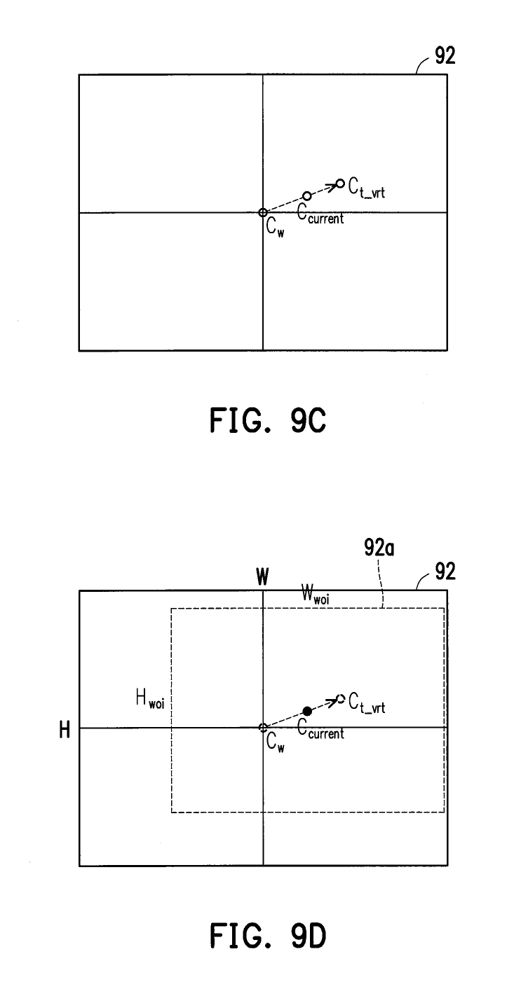

For example, FIG. 9A to FIG. 9D are schematic diagrams illustrating defining a window of interest according to an embodiment of the invention. Referring to FIG. 9A first, the embodiment utilizes three steps of feature point detection, feature point description, and feature point matching in the feature point matching algorithm to recognize an object of interest E in a wide image 92, describe the object of interest E by a feature vector, and then utilize the feature vector to search an object of interest E′ corresponding to the object of interest E in a tele image 94. The embodiment uses an apex of the object of interest E as a feature point w, thereby finding a matching point t corresponding to the feature point w in the object of interest E′ by the feature point matching method.

Next, referring to FIG. 9B, the embodiment continues utilizing the feature point to calculate the correspondence of the wide image 92 and the tele image 94, wherein a vector vₜ from a position pₜ of a matching point t to a center cₜ of the tele image 94 in the tele image 94 may be calculated, for example. Then, the vector vₜ is multiplied by a ratio of the magnification of the wide-angle lens to the magnification of the telephoto lens (i.e., Z_{wide}/Zₜₑₗₑ) to obtain a convert vector vₜ_{_}ᵥᵣₜ. At last, the convert vector vₜ_{_}ᵥᵣₜ is brought into the wide image 92. After the convert vector vₜ_{_}ᵥᵣₜ is added from a position p_{w} of the feature point w, a corresponding virtual center cₜ_{_}ᵥᵣₜ of the center cₜ of the tele image can be obtained. The calculation formula is as follows:

$$\begin{matrix}{v}_{t} = {c}_{t} - {p}_{t} & ( 1 ) \\ {v}_{t \_ vrt} = \frac{{Z}_{wide}}{{Z}_{tele}} {v}_{t} & ( 2 ) \\ {c}_{t \_ vrt} = {p}_{w} + {v}_{t \_ vrt} & ( 3 )\end{matrix}$$

Thereafter, referring to FIG. 9C, after the position of the virtual center cₜ_{_}ᵥᵣₜ is obtained, the position of the intermediate points of the window of interest corresponding to any of the zoom factor can be calculated in the process of zooming from the magnification Z_{wide} of the wide-angle lens to the magnification Zₜₑₗₑ of the telephoto lens. Take the zoom factor Z_{current} as an example, a corresponding intermediate point c_{current} can be inserted between a center c_{w} of the wide image 92 and the virtual center cₜ_{_}ᵥᵣₜ according to a proportional relationship between the zoom factor Z_{current} and the magnifications Z_{wide} and Zₜₑₗₑ of the wide-angle lens and the telephoto lens. The calculation formula is as follows:

$${c}_{current} = \frac{{Z}_{current} - {Z}_{wide}}{{Z}_{tele} - {Z}_{wide}} ( {c}_{t \_ vrt} - {c}_{w} ) + {c}_{w} \qquad ( 4 )$$

At last, referring to FIG. 9D, after the position of the intermediate point c_{current} is obtained, the position can be used as a center to define the range of the window of interest 92a. A width W_{woi} and a height H_{woi} of the window of interest 92a may be calculated from a width W and a height H of the wide image 92 according to a proportional relationship between the zoom factor Z_{current} and the magnifications Z_{wide} and Zₜₑₗₑ of the wide-angle lens and the telephoto lens. The calculation formula is as follows:

$$\begin{matrix}{W}_{woi} = \frac{{Z}_{wide}}{{Z}_{current}} W & ( 5 ) \\ {H}_{woi} = \frac{{Z}_{wide}}{{Z}_{current}} H & ( 6 )\end{matrix}$$

The window of interest defined by the above method can be used to define the range of the images captured in the wide-angle lens at any zoom factor in the process of zooming from the magnification Z_{wide} of the wide-angle lens to the magnification Zₜₑₗₑ of the telephoto lens. However, in the zooming process, since the center of the window of interest may be gradually moved toward the virtual center corresponding to the center of the tele image, the object of interest appears in the image will be at the same position when the zoom factor is magnified to the magnification of the telephoto lens and required to switch from the wide image to the tele image. Thus, the position and the size of the object of interest which the user is concerned about has no significant change before and after the switching, thereby reducing the image discontinuity perception of the user caused by the image switching.

It should be noted that when the zooming operation is performed by the user, an original capture scene may be changed. At this time, if the image is zoomed according to the previous calculated method, the situation of image discontinuity will also be generated because the position of the object of interest is changed. In this regard, an embodiment of the invention is to detect the scene change in the image in the zooming process and recalculate the position of the window of interest used in the following zooming to solve the problem of image discontinuity when the scene is changed.

Specifically, in the embodiment of FIG. 6, the image processing circuit 66 of the image capturing apparatus 60 further includes a scene determination module (not shown), which can determine whether the scene has a change in the wide image and the tele image in the zooming process, for example. If the scene determination module determines that there is a change, the zoomed image capture module 664 may calculate the intermediate points between the center of the window of interest and the virtual center to be used as the centers of the window of interest for capturing the zoomed image in the subsequent zooming process according to the center of the window of interest, the virtual center of the tele image, and the zoom factor which are currently used.

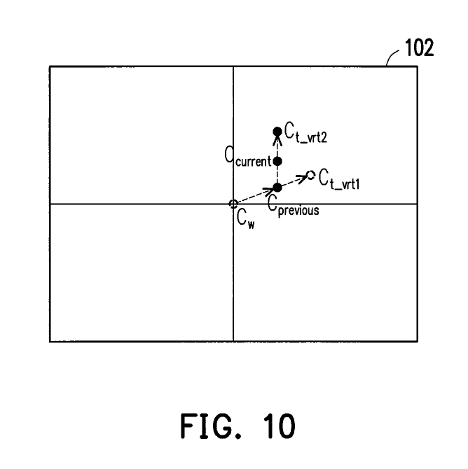

For example, FIG. 10 is a schematic diagram illustrating defining a window of interest according to an embodiment of the invention. Referring to FIG. 10, the embodiment is to use the method disclosed in FIG. 9A to FIG. 9D to calculate the center and the size of the window of interest at any zoom factor in the process of zooming from the magnification Z_{wide} of the wide-angle lens to the magnification Zₜₑₗₑ of the telephoto lens (the center of the window of interest moves from the center c_{w} of a wide image 102 to a virtual center cₜ_{_}ᵥᵣₜ₁ of the tele image). If the scene has a change in the wide image and the tele image, a center cₚᵣₑᵥᵢₒᵤₛ of the previously zoomed window of interest is used as a start point to recalculate the position of a new virtual center cₜ_{_}ᵥᵣₜ₂ of the tele image. The intermediate point c_{current} between the center cₚᵣₑᵥᵢₒᵤₛ of the window of interest and the virtual center cₜ_{_}ᵥᵣₜ₂ is calculated again to be used as the center of the window of interest for capturing the zoomed image in the subsequent zooming process.

By the above method, the image capturing apparatus of the embodiment can change the range of the captured image in response to the change of the image scene in the zooming process, such that the range of the zoomed image continues moving toward the object of interest in the image, so as to ensure that the display of the object of interest is continuous when the image is switched.

In summary, in the image capturing apparatus and the image zooming method thereof of the invention, the image capturing apparatus transfers the image captured in the wide image and the tele image from the image center to the center of the object of interest in the process of capturing and displaying the zoomed image according to the zoom factor input by the user, so as to ensure that the positions of the object of interest in the image before and after switching are the same when the image is switched subsequently. Thus, the discontinuous feeling caused by the bumping of the subject object in the image can be reduced. The invention further monitors the scene change in the image zooming process and timely adjusts the captured image range, such that the zoomed image continues moving toward the object of interest in the image, so as to ensure that the display of the object of interest is continuous when the image is switched subsequently.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. An image zooming method of an image capturing apparatus, adapted to the image capturing apparatus with a wide-angle lens and a telephoto lens, wherein a field of view (FOV) of the wide-angle lens is larger than a field of view of the telephoto lens, the method comprising:
respectively capturing a wide image and a tele image by utilizing the wide-angle lens and the telephoto lens to;
recognizing an object of interest in the wide image and the tele image; and
receiving a zoom factor to zoom the wide image or the tele image, and adjusting a capture range of a window of interest (WOI) for capturing the wide image during zooming, such that a center of the wide image captured by the window of interest moves toward the object of interest, and
when the zoom factor reaches a magnification of the telephoto lens, the object of interest is at the same position in the wide image captured by the window of interest and the tele image.

2. The method according to claim 1, wherein the step of adjusting the capture range of the window of interest for capturing the wide image during zooming such that the center of the wide image captured by the window of interest moves toward the object of interest comprises:
capturing at least one feature point and at least one corresponding matching point of the object of interest in the wide image and the tele image;
calculating a corresponding virtual center of a center of the tele image in the wide image by utilizing the feature point and the matching point;
calculating a plurality of intermediate points between the center of the wide image and the virtual center to be used as centers of the window of interest for capturing a zoomed image during zooming according to the center of the wide image, the virtual center of the tele image, and the zoom factor; and
capturing the zoomed image from the wide image and the tele image by utilizing the window of interest according to the center of the window of interest and the zoom factor.

3. The method according to claim 2, wherein the step of capturing the feature point and the corresponding matching point of the object of interest in the wide image and the tele image comprises:
capturing the feature point of the object of interest in the wide image and searching the matching point corresponding to the feature point in the tele image.

4. The method according to claim 3, wherein the step of calculating the corresponding virtual center of the center of the tele image in the wide image by utilizing the feature point and the matching point comprises:
calculating a vector from each of the matching point in the tele image to the center of the tele image;
multiplying the vector by a ratio of a magnification of the wide-angle lens to the magnification of the telephoto lens to obtain a convert vector; and
calculating the corresponding virtual center of the center of the tele image in the wide image from the feature point corresponding to the matching point in the wide-angle lens plus the convert vector.

5. The method according to claim 2, wherein the step of capturing the feature point and the corresponding matching point of the object of interest in the wide image and the tele image comprises:
capturing the feature point of the object of interest in the tele image and searching the matching point corresponding to the feature point in the wide image.

6. The method according to claim 5, wherein the step of calculating the corresponding virtual center of the center of the tele image in the wide image by utilizing the feature point and the matching point comprises:
calculating a vector from each of the feature point in the tele image to the center of the tele image;
multiplying the vector by a ratio of a magnification of the wide-angle lens to the magnification of the telephoto lens to obtain a convert vector; and
calculating the corresponding virtual center of the center of the tele image in the wide image from the matching point corresponding to the feature point in the wide-angle lens plus the convert vector.

7. The method according to claim 2, wherein the step of calculating the intermediate points between the center of the wide image and the virtual center to be used as the centers of the window of interest for capturing the zoomed image during zooming according to the center of the wide image, the virtual center of the tele image, and the zoom factor comprises:
inserting the intermediate points between the center of the wide image and the virtual center according to a proportional relationship between the zoom factor and the magnifications of the wide-angle lens and the telephoto lens.

8. The method according to claim 2, further comprising:
multiplying a size of the wide image by a ratio of a magnification of the wide-angle lens to the zoom factor corresponding to each the window of interest during zooming to obtain a size of the window of interest.

9. The method according to claim 2, wherein the step of capturing the zoomed image from the wide image and the tele image by utilizing the window of interest according to the center of the window of interest and the zoom factor further comprises:
determining whether a scene has a change in the wide image and the tele image; and
if there is a change, calculating the intermediate points between a center of the window of interest and the virtual center to be used as the centers of the window of interest for capturing the zoomed image in a subsequent zooming process according to the center of the window of interest, the virtual center of the tele image, and the zoom factor which are currently used.

10. An image capturing apparatus, comprising:
a wide-angle lens, capturing a wide image;
a telephoto lens, capturing a tele image;
an image processing circuit, coupled to the wide-angle lens and the telephoto lens, processing the wide image and the tele image to generate a zoomed image, comprising:
an object of interest recognition module, recognizing an object of interest in the wide image and the tele image; and
a zoomed image capture module, receiving a zoom factor to zoom the wide image or the tele image, and adjusting a capture range of a window of interest for capturing the wide image during zooming, such that a center of the wide image captured by the window of interest moves toward the object of interest, and
when the zoom factor reaches a magnification of the telephoto lens, the object of interest is at the same position in the wide image captured by the window of interest and the tele image.

11. The image capturing apparatus according to claim 10, wherein the object of interest recognition module further captures at least one feature point and at least one corresponding matching point of the object of interest in the wide image and the tele image, and the zoomed image capture module comprises calculating a corresponding virtual center of a center of the tele image in the wide image by utilizing the feature point and the matching point, calculating a plurality of intermediate points between the center of the wide image and the virtual center to be used as centers of a window of interest for capturing the zoomed image during zooming according to the center of the wide image, the virtual center of the tele image, and a zoom factor, and capturing the zoomed image from the wide image by utilizing the window of interest according to the center of the window of interest and the zoom factor.

12. The image capturing apparatus according to claim 11, wherein the object of interest recognition module comprises capturing the feature point of the object of interest in the wide image and searching the matching point corresponding to the feature point in the tele image.

13. The image capturing apparatus according to claim 12, wherein the zoomed image capture module comprises calculating a vector from each of the matching point in the tele image to the center of the tele image, multiplying the vector by a ratio of a magnification of the wide-angle lens to the magnification of the telephoto lens to obtain a convert vector, and calculating the corresponding virtual center of the center of the tele image in the wide image from the feature point corresponding to the matching point in the wide-angle lens plus the convert vector.

14. The image capturing apparatus according to claim 10, wherein the object of interest recognition module comprises capturing the feature point of the object of interest in the tele image and searching the matching point corresponding to the feature point in the wide image.

15. The image capturing apparatus according to claim 14, wherein the zoomed image capture module comprises calculating a vector from each of the feature point in the tele image to the center of the tele image, multiplying the vector by a ratio of a magnification of the wide-angle lens to the magnification of the telephoto lens to obtain a convert vector, and calculating the corresponding virtual center of the center of the tele image in the wide image from the matching point corresponding to the feature point in the wide-angle lens plus the convert vector.

16. The image capturing apparatus according to claim 10, wherein the zoomed image capture module comprises inserting the intermediate points between the center of the wide image and the virtual center according to a proportional relationship between the zoom factor and the magnifications of the wide-angle lens and the telephoto lens.

17. The image capturing apparatus according to claim 10, wherein the zoomed image capture module further multiplying a size of the wide image by a ratio of the magnification of the wide-angle lens to the zoom factor corresponding to each the window of interest in the zooming process to obtain a size of the window of interest.

18. The image capturing apparatus according to claim 10, wherein the image processing circuit further comprises:
a scene determination module, determining whether a scene has a change in the wide image and the tele image, wherein if there is a change, the zoomed image capture module calculates the intermediate points between a center of the window of interest and the virtual center to be used as the centers of the window of interest for capturing the zoomed image in a subsequent zooming process according to the center of the window of interest, the virtual center of the tele image, and the zoom factor which are currently used.
